(19) United States
(12) Patent Application Publication
(10) Pub. No.: US 2015/0019256 A1
(43) Pub. Date: Jan. 15, 2015

(54) PATIENT STATUS UPDATE PORTAL

(71) Applicant: Covidien LP, Mansfield, MA (US)

(72) Inventors: Peter Doyle, Vista, CA (US); Gardner James Kimm, Carlsbad, CA (US); Mehdi M. Jafari, Laguna Hills, CA (US); Warren Sanborn, Escondido, CA (US); Sidney A. Jacobi, San Marcos, CA (US); Robert Hartman, San Marcos, CA (US)

(21) Appl. No.: 13/941,909

(22) Filed: Jul. 15, 2013

(51) Int. Cl. G06Q 50/24; G06Q 10/10

(52) U.S. Cl. CPC G06Q 50/24; G06Q 10/10
USPC 705/3

(57) ABSTRACT

A patient communication system includes a patient communication device, a facility update device, a server, and a portal. The patient communication device is in the bedside environment of a patient within the medical facility. The patient uses the patient communication device to post statuses and send messages to individuals outside of the medical facility to the server. The facility update device provides updates to the server from clinicians and medical devices in the bedside environment of the patient. The server compiles the information from the patient communication device and from the facility update device and automatically posts the status updates to a portal associated with the patient. The portal is accessed by the individuals associated with the patient to receive updates concerning the status of the patient.

### TECHNICAL FIELD

The present disclosure relates generally to communication in a medical institution, more specifically, communicating the status of a patient within the medical institution to individuals associated with the patient.

### BACKGROUND

Traditional communication between family or friends and a patient in a hospital or similar medical institution is slow, complex, and unreliable. For example, a family member waiting for news of a patient's diagnostic results or for information regarding a discharge time may have no other option that to call the patient directly on an in-room phone or call to speak to medical personnel at the facility. The patient may be inaccessible or may need to defer to a physician, who in turn may not arrive with results or other information until the next in-room visit which will occur at a future time unknown to the patient. Each call to the medical personnel at the facility requires the medical personnel to answer the phone, look up the patient information, and possibly transfer the call to the patient or another area of the facility to repeat the process requiring a significant amount of the medical personnel's time for each call. Moreover, if information is available, it may be limited to the patient's recollection of complex information relayed by a physician during a past visit. This inefficient communication results in repeated calls to the patient, incomplete or inaccurate status information, inability to schedule a visit or pickup at discharge, and time costs to clinical staff fielding multiple phone calls from the family/friend. Moreover, the inefficient communication can cause anxiety for the patient and family/friends of the patient.

### SUMMARY

According to aspects of the present disclosure, a patient communication system includes a patient communication device, a facility update device, a portal, and a first server. The patient communication device is associated with a patient in a medical facility. The patient communication device includes a patient interface and is configured to receive status updates from the patient via the patient interface. The facility update device includes a clinician interface configured to receive patient status updates via the clinician interface. The portal is configured to display the status updates received by the patient communication device and the facility update device. The portal is securely accessible by individuals outside of the medical facility. The first server is in communication with the patient communication device, the facility update device, and the portal via a network. The first server receives the status updates from the patient communication device and the facility update device. The first server is configured to post the status updates to the portal.

According to another aspect of the present disclosure, a method for communicating the status of a patient within a medical facility to identified individuals includes identifying an individual, authenticating the individual, updating the status of the patient, and automatically communicating the updated status of the patient. Identifying an individual may include identifying an individual to receive status updates of the patient in a patient communication system. The patient communication system may include a patient communication device, a facility update device, a server, and a portal associated with the patient.

By automatically updating individuals outside of the medical facility of the status of a patient within the medical facility the individuals can be better informed about the status of the patient within the medical facility. Moreover, the individuals are informed without requiring direct communication with the patient or the staff of the medical facility. This allows the medical facility to reduce the resources, i.e. staff, dedicated to communicating with individuals outside of the medical facility to update the individuals on the status of patients within the medical facility. Further, the information received by the individuals outside the medical facility can have increased accuracy and increased completeness. Thus, the individuals outside the medical facility will be better informed on the status of a patient within the medical facility. Individuals outside the medical facility will also be able to receive status updates without directly communicating with the patient and/or clinicians allowing the individuals to receive status updates even when the patient and/or clinicians are unavailable.

Certain embodiments of the present disclosure may include some, all, or none of the above advantages. One or more other technical advantages may be readily apparent to those skilled in the art for the figures, descriptions, and claims included herein. Moreover, while specific advantages have been enumerated above, various embodiments may include all, some, or none of the enumerated advantages.

### BRIEF DESCRIPTION OF THE DRAWINGS

There are shown in the drawings embodiments, which are exemplary, it being understood that the disclosure is not limited to the precise arrangements and instrumentalities shown.

FIG. 1 is a patient communication system in accordance with the present disclosure;

FIG. 2 is a patient communication device in accordance with the present disclosure;

FIGS. 3A and 3B are facility update devices provided in accordance with the present disclosure; and

FIG. 4 is a medical communication system in accordance with the present disclosure for use with the patient communication system of FIG. 1.

### DETAILED DESCRIPTION

A system and method for communicating the status of a patient within a medical facility to individuals associated with the patient outside of the medical facility will now be described in detail with reference to the drawings in which like reference numerals designate identical or corresponding elements in each of the several views.

As used herein, bedside refers to an environment in close proximity to a patient being treated. Items placed within a bedside environment should be near enough to the patient that a physician treating the patient and/or the patient can access the items. It should be noted that a bedside environment need not include a bed. For example, instead of a bed, a patient can be contained within an incubator, an ambulance, a gurney, a cot, an operating table, and the like. Similarly, an apparatus that can provide information to an individual, such as a physician, located within the bedside environment can be considered bedside apparatus even if necessary portions of the apparatus are in a location remote from the patient (e.g., servers, databases, etc.). As used herein, “clinician” refers to any personnel at a medical facility including but not limited to physicians, nurses, laboratory technicians, administrators, and support staff. As used herein, medical facility refers to any singular or group of medical providers providing medical services to patients including but not limited to hospitals, clinics, medical research facilities, or hospital networks.

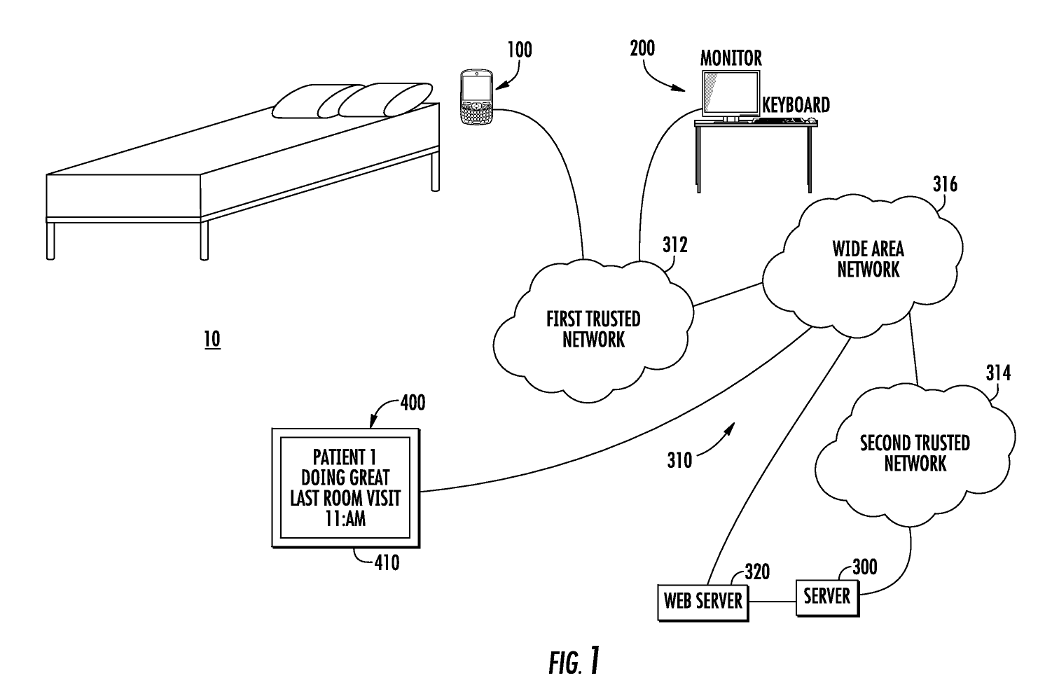

Referring to FIG. 1, a patient communication system 10 is provided in accordance with the present disclosure incorporating a patient communication device 100, a facility update device 200, a server 300, and a portal 400. Each device 100, 200 and portal 400 are discussed in the singular, however, it is contemplated that system 10 can include a plurality of patient communication devices 100, facility update devices 200, server 300, and portals 400. Each device 100, 200 and portal 400 are in communication with server 300 through a network 310. Network 310 can include wired and wireless components. In embodiments, server 300 is in a remote location and network 310 includes a first trusted network 312 and a second trusted network 314 connected through a wide-area network 316 such that only devices in the first trusted network 312 and the second trusted network 314 are capable of deciphering data transmitted through wide-area network 316 between the first and second trusted networks 312, 314. It will be appreciated that any known means of encryption can be used to securely transmit data between first and second trusted networks 312, 314. It is contemplated that patient communication system 10 includes a plurality of patient communication devices 100 and portals 400, each associated with a particular patient, and a plurality of facility update devices 200, either shared between clinicians and/or each associated with a particular clinician.

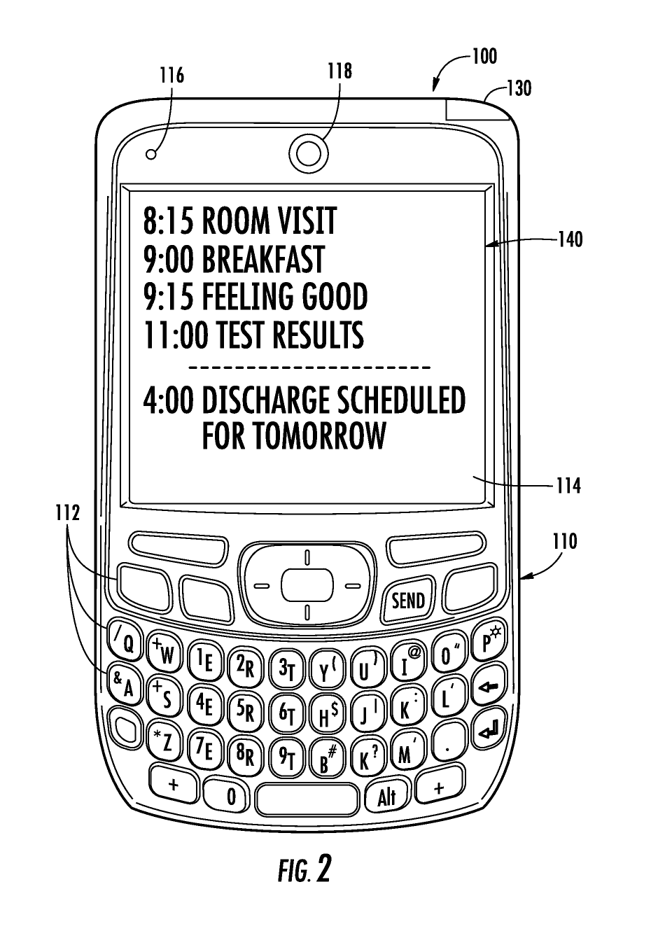

Referring to FIG. 2, an exemplary patient communication device 100 includes a patient interface 110, a network interface 130, and a display 140. Patient interface 110 includes a plurality of buttons 112 and/or a touch screen 114 and is configured to accept input from the patient. Plurality of buttons 112 can include buttons configured in QWERTY format and/or buttons configured to perform predefined tasks, i.e. up, down, left, right, select, record, etc. Touch screen 114 can be integrated into display 140. In embodiments, patient interface 110 includes a microphone 116 and/or a camera 118 to accept input from the patient. Network interface 130 can be wired and/or wireless and is configured to communicate with server 300 via network 310. Display 140 shows status updates and communications to the patient as discussed in detail below. It is contemplated that patient communication device 100 can be a general purpose device, e.g., a general purpose computer, smart phone, or tablet, running a program and/or application. Moreover, it is also contemplated that patient communication device 100 can be the patient's personnel general purpose device running an application and/or program which is installed before or after the patient is admitted to the medical facility.

Patient communication device 100 is positioned within the beside environment of patient. Patient can use patient communication device 100 to communicate with identified individuals or individuals associated with the patient, to approve individuals, configure a patient filter, and to post status updates to portal 400 as discussed in detail below.

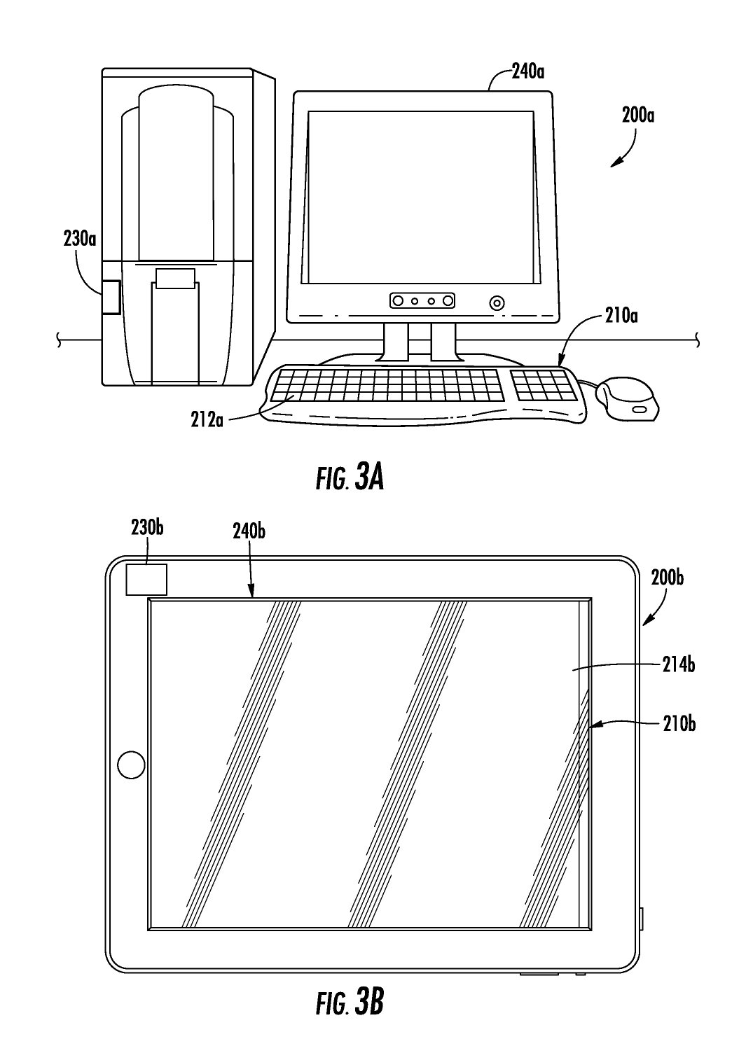

Referring to FIGS. 3A and 3B, facility update devices 200a, 200b include a clinician interface 210a, 210b, a network interface 230a, 230b, and a display 240a, 240b. Clinician interface 210a includes a plurality of buttons 212a and clinician interface 210b includes a touch screen 214b which are configured to allow a clinician to choose a particular patient and are configured to accept input from the clinician related to the particular patient. It is contemplated, similar to patient communication device 100, that a clinician interface can include both a plurality of buttons 212a and a touch screen 214b. It is also contemplated that facility updated devices 200a, 200b can be a general purpose device, e.g., a general purpose computer, smart phone, or tablet, running a program and/or application. Network interfaces 230a, 230b can be wired and/or wireless and are configured to communicate with server 300 via network 310. Displays 240a, 240b show information in response to the input of the clinician as discussed in detail below.

In embodiments, facility update device 200b is carried by a clinician. Facility update device 200b can be specific to each clinician and/or multiple clinicians can share a facility update device 200b. Clinicians can use facility update devices 200a, 200b to provide updates to portal 400 as discussed in detail below.

Referring back to FIG. 1, portal 400 is configured to display information and status updates with respect to the specific patient associated with the portal 400. Each patient is associated with a portal 400 such that each portal 400 is associated with a specific patient. Portal 400 is accessible by individuals associated with a patient. Portal 400 is in communication with server 300. Portal 400 can communicate with server 300 through wide area network 316. In embodiments, portal 400 is a website hosted on server 300. Portal 400 can also be a website or application hosted on a web or application server 320 in communication with server 300. In some embodiments, portal 400 is in communication with server 300 via network 310 and/or wide-area network 316. In particular embodiments, portal 400 is viewable by an application and/or program on a remote device 410, e.g., a mobile phone, tablet, personnel computer, etc. In certain embodiments, individuals associated with a patient can post messages within portal 400 to communicate with the patient associated with the portal 400 as discussed in detail below.

Server 300 is in one-way or two-way communication with patient communication device 100, facility update device 200, and portal 400 via network 310. Server 300 is configured to update patient communication device 100, facility update device 200, and portal 400 in response to input received by patient communication device 100, facility update device 200, and portal 400 as discussed in detail below. Server 300 can include a patient filter and/or a facility filter.

The patient filter can be configurable by the patient to limit the types of information or updates that are posted to portal 400 by server 300. For example, the patient can limit the types of updates posted to portal 400 to communications initiated by the patient or the patient can limit the types of updates posted to portal 400 to updates preapproved by the patient. The patient filter can limit the types of updates and messages initiated by any component of patient communication system 10, i.e. patient communication device 100, facility update device 200, and/or portal 400. In embodiments, the patient filter can be customized based on the individual and/or groups of individuals accessing portal 400.

The facility filter can be configured by the medical facility to limit the types of information or updates that are posted to portal 400 by server 300. A network administrator or a clinician can be authorized to configure the facility filter. It is contemplated that the facility could limit the types of updates posted to portal 400 to comply with legal obligations, privacy policies, and/or federal privacy regulations, e.g., HIPAA. The facility filter can limit the types of updates and messages initiated by any component of patient communication system 10, i.e. patient communication device 100, facility update device 200, and/or portal 400.

The following discussion of the operation of patient communication system 10 is meant to be exemplary and not limiting in any manner to other methods of operation in accordance with the present disclosure. A patient is admitted and/or scheduled for admittance to a medical facility the patient is associated with a portal 400 of patient communication system 10. The patient's information can be captured in a facility update device 200 to associate the patient with a portal 400. Before, during admission, or anytime during the patient's stay, the patient can provide a list of individuals associated with the patient authorized to access the portal 400 associated with the patient. In embodiments, the patient provides a patient designee or designees to provide a list of individuals associated with the patient authorized to access the portal 400 associated with the patient. It is also contemplated that a patient may opt out of patient communication system 10 and not provide a list of associated individuals and decline to have a portal 400 associated with the patient. While it is anticipated that patient communication system 10 includes a plurality of portals 400 with each portal 400 being associated with a particular patient, as discussed in detail below only the individual portal 400 associated with a single patient is discussed in detail.

In embodiments, the patient or a patient designee can group the associated individuals into groups such as friends, family, and colleagues. As discussed below, the groups an individual is a member of can be used to determine the type and content of the posts viewable by the individual.

In some embodiments, the patient provides and/or groups individuals associated with the patient before the patient is admitted to the medical facility. In such embodiments, the patient can download an application and/or program to a personnel general purpose device, to be used as a patient communication device 100. For example, the patient downloads an application to a smart phone and associates individuals from a contact list stored on the smart phone. It is also contemplated that the patient can configure the patient filter before the patient is admitted to the medical facility by using a personnel general purpose device.

It is anticipated that each of the individuals associated with the patient will need to be authenticated before gaining access to portal 400, an example of an authentication process is discussed in detail below, however, any known method of authenticating an individual user of a computer or mobile device may be used. For each individual of the list of individuals associated with the patient, the patient or patient designee provides the medical facility with the individuals contact information, i.e. name, phone number, and/or email address. In embodiments, the individuals contact information is inputted into patient communication device 100 by the patient or the patient designee. When the patient communication system 10 receives the contact information of individuals associated with a patient, the patient communication system 100 communicates with server 300. Server 300 sends a message, i.e. an email, a text, or a phone call, to each of the individuals associated with a patient to provide each individual with instructions on how to access portal 400 and a unique code to access portal 400. Each individual follows the instructions and inputs the code into portal 400 to authenticate themselves or a remote device 410. In some embodiments, once authenticated each individual associated with the patient creates a unique password for future access to portal 400. In particular embodiments, once a remote device 410, i.e. computer, smart phone, tablet, or other mobile device, is authenticated, remote device 410 becomes an authorized remote device 410a and remains authenticated with portal 400.

The patient can use the patient communication device 100 to add individuals associated with the patient authorized to access portal 400, provide authenticated individuals patient status updates, and communicate with authenticated individuals. The patient can also setup filters to designee which individuals or groups of individuals receive which type of updates from patient communication system 10.

Patient communication device 100 can have a limited functional mode, a fully functional mode, and a configurable functional mode. When patient communication device is in a limited functional mode, the patient can only choose from a list of predefined messages or emoticons to update or post to the portal such as “OK,” “Please Call,” “Doing Better,” “:),” etc. In embodiments, in the limited functional mode the patient cannot provide individuals associated with the patient. For example, a guardian of the patient can request a patient communication device in limited functional mode to control the individuals the patient communicates with. In the fully functional mode, the patient can choose from a list of predefined messages or emoticons to post to the portal or can create custom messages or postings using patient interface 110 of patient communication device 100. In some embodiments, in the fully function mode the patient can record audio messages and/or video messages to post to portal 400 using microphone 116 and/or camera 118 of patient interface 110. In some embodiments, the patient can type or record a message that is saved on server 300 but not sent to an individual or posted to portal 400 until a predetermined amount of time has passed or a predetermined event occurs. When patient communication device 100 is in the configurable functional mode, the functions of patient communication device 100 are configurable by a clinician, a designee, and/or a guardian of the patient. It is contemplated that the functions of the patient communication device 100 would be configured based on the condition, age, and/or mental state of the patient. It is also contemplated that the medical facility can have a variety of patient communication devices 100, each with a different functional mode to provide in the bedside environment of each patient.

When facility update device 200 receives an update associated with the patient, facility update device 200 transmits the update to server 300 via network 310. Server 300 determines the type of update, i.e. status update, diagnosis, treatment, or tests. Server 300 compares the type of update to the facility filter to determine if the update is of the type the medical facility authorizes to post to portals 400. If the update is of the type the medical facility authorizes to be posted to portal 400, server 300 compares the type of update to the patient filter to determine if the update is of the type the patient authorizes to be posted to portal 400. If the update passes through both the facility and the patient filter, server 300 posts the update to portal 400. In embodiments, server 300 pushes the update to authenticated devices. Server 300 can push the update by emailing an authorized individual, texting an authorized individual, posting within an application, and/or calling an authenticated device.

Portal 400 can receive updates from server 300, receive communication from individuals associated with the patient, authenticate individuals associated with the patient, authenticate devices of individuals associated with the patient, and receive communication from authenticated devices. Portal 400 can authenticate the individuals associated with the patient and/or devices upon initial access in one manner and can authenticate the individuals associated with the patient and/or devices on each subsequent access in a different manner. When an authenticated individual accesses portal 400, the authenticated individual can view the current status of the patient, view postings of the patient, and view updates provided by the medical facility. It will be appreciated that the authenticated individual can only view items which have passed through both the facility and the patient filter. In embodiments, authenticated individuals can view messages sent by the patient to the individual or a group of individuals of which the authenticated individual is a member. In some embodiments, when the authenticated individual is a designee of the patient, the designee can access portal 400 to associate individuals with the patient, add or remove individuals from groups of associated individuals, and customize the patient filter to determine what type of updates and postings go to individuals or groups of individuals.

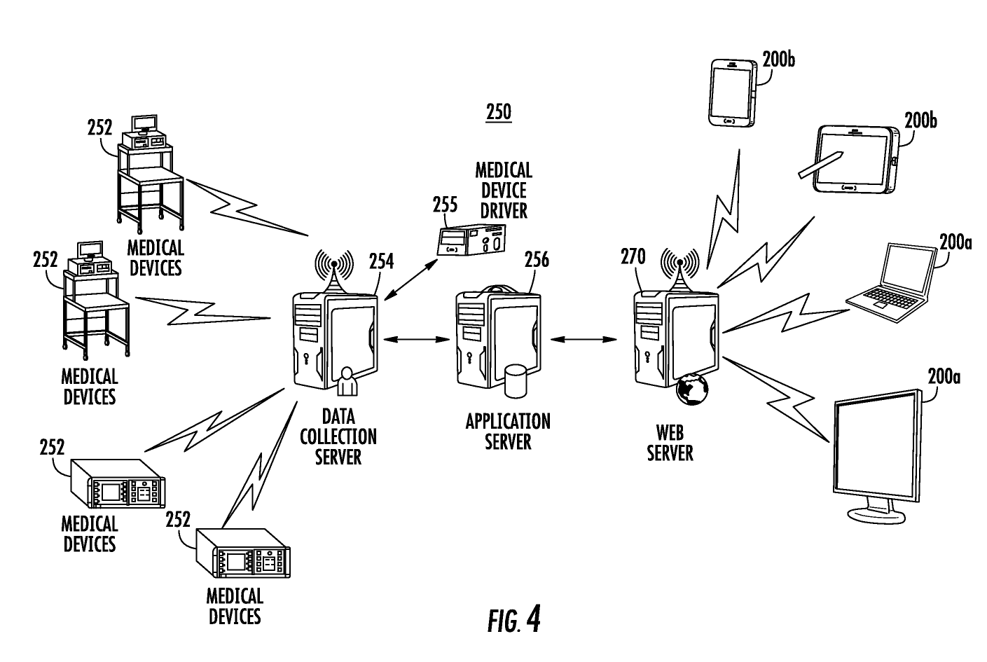

Referring to FIG. 4, facility update devices 200a, 200b can be part of a medical communication system 250 including one or more medical devices 252, a data collection server 254, an application server 256, a web server 270, and a medical device driver 255. Such a medical communication system is disclosed in commonly owned U.S. patent application Ser. No. 13/835,095 filed Mar. 15, 2013, the disclosure of which is hereby incorporated by reference in its entirety. Each medical device 252 may be connected to a data collection server 254, which stores patient parameters in a database. Application server 256 retrieves the patient parameters from the database and processes the patient parameters into display parameters for web server 270. Facility update devices 200a, 200b request and receive the display parameters and display the display parameters through a browser, thereby enabling clinicians using facility update devices 200a, 200b to view the display parameters in remote locations.

Medical devices 252 may be any devices that are used for tracking or treating patients. For example, medical devices 252 may include a ventilator connected to a patient to deliver respiratory therapy. In short, medical devices 252 may include any suitable combination of software, firmware, and hardware used to support any medical function and/or operation. It should be noted that any suitable number of medical devices 252 may be included in medical communication system 250. Medical devices 252 may generate output data tracked by medical devices 252.

Medical devices 252 may be communicatively coupled to data collection server 254 via network 300. Medical devices 252 may be communicatively coupled to other suitable devices including data collection server 254, application server 256, web server 270, facility update devices 200a, 200b, and medical device driver 255.

Medical communication system 250 may include one or more data collection servers 254, referred to primarily in the singular throughout this disclosure. Data collection server 254 may include one or more electronic computing devices operable to receive, transmit, process, and store data associated with medical communication system 250. Data collection server 254 receives patient parameters from medical devices 252. The stored data may be accessed by application server 256.

Medical communication system 250 may include one or more application servers 256, referred to primarily in the singular throughout this disclosure. Application server 256 may include one or more electronic computing devices operable to receive, transmit, process, and store data associated with medical communication system 250. Application server 256 creates a data service, which runs on a conventional web services platform for transmitting data to web server 270. Application server 256 may maintain an activity log that logs data requests from facility update devices 200a, 200b to track certain activities performed at facility update devices 200a, 200b. Therefore, if a clinician logs a visit to a particular patient or enters a status update for a particular patient the log or entry may trigger a data request that is logged by application server 256. If any changes are detected, application server 256 may flag those changes for presentation to users on remote devices, i.e., facility update devices 200a, 200b and/or portals 400.

Medical communication system 250 may include one or more web servers 270. Web server 270 may include one or more electronic computing devices operable to receive, transmit, process, and store data associated with medical communication system 250. Web server 270 creates a data service that runs on a conventional web services platform for receiving data from application server 256 and transmitting data to facility update devices 200a, 200b. For example, web server 270 may receive webpage data from application server 256 and transmitted, upon request in certain embodiments, to facility update devices 200a, 200b and/or portals 400.

Although FIG. 4 depicts separate devices for data collection server 254, application server 256, and web server 270, it will be readily apparent that the functions of these devices may be combined into a single device that receives patient parameters from medical devices 252 and transforms the patient parameters into display parameters. It will also be understood that this single device may alternatively transmit the display parameters to facility update devices 200a, 200b and/or portals 400. In certain embodiments, data collection server 254 may be a bedside device that receives patient parameters from medical devices 252.

Application server 256 and/or web server 270 can be in communication with server 300 of patient communication system 10. Application server 256 can automatically provide updates from the medical facility to server 300, e.g., times when a clinician visits the patient's room, changes in the status of the patient, changes in the diagnosis of the patient, etc. In this way, updates from facility update devices 200a, 200b are automatically posted to portals 400, i.e. no additional steps are required by clinicians to update patient communication system 10.

The various GUIs disclosed herein are shown for purposes of illustration only. Accordingly, the present disclosure is not limited by the particular GUI or data entry mechanisms contained within views of the GUI. Rather, those skilled in the art will recognize that any of a variety of different GUI types and arrangements of data entry, fields, selectors, and controls can be used to access system. Further, the computing devices depicted herein can be functionally and/or physically implemented with other computing devices and the disclosure should not be limited by the particular exemplary configuration shown.

The present disclosure also can be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

This disclosure can be embodied in other forms without departing from the spirit or essential attributes thereof. Accordingly, reference should be made to the following claims, rather than to the foregoing specification, as indicating the scope of the disclosure.

What is claimed:

1. A system for communicating patient information comprising:
a patient communication device associated with a patient in a medical facility and including a patient interface, the patient communication device configured to receive status updates from the patient via the patient interface;
a facility update device including a clinician interface configured to receive patient status updates via the clinician interface;
a portal configured to display the status updates received by the patient communication device and the facility update device, the portal securely accessible by individuals outside of the medical facility; and
a first server in communication with the patient communication device, the facility update device, and the portal via a network, the first server receiving the status updates from the patient communication device and the facility update device and posting the status updates within the portal.

2. The system according to claim 1, wherein the facility update device is part of a medical communication system including a medical device in communication with a second server, the second server receiving status updates from the facility update device and the medical device, the second server in communication with the first server and configured to transmit the status updates from the facility update device and the medical device to the first server.

3. The system according to claim 2, wherein the first server includes a facility filter configured to verify the type of status update is authorized by the medical facility to post to the portal before posting the status update to the portal.

4. The system according to claim 2, wherein the first server includes a patient filter configured to verify the type of status update is authorized by the patient to post to the portal before posting the status update to the portal.

5. The system according to claim 1, wherein the portal is accessible by a remote device.

6. The system according to claim 5, wherein the remote device is authenticated by the portal before the remote device receives status updates.

7. The system according to claim 6, wherein the portal pushes status updates to the remote device.

8. The system according to claim 5, wherein the remote device is at least one of a smart phone, a tablet, a notebook computer, or a general purpose computer.

9. A method for communicating the status of a patient within a medical facility to identified individuals, the method comprising:
identifying the individual to receive status updates of the patient from a patient communication system, the patient communication system including:
a patient communication device;
a facility update device;
a server; and
a portal associated with the patient;
authenticating the individual within the patient communication system;
updating the status of the patient within the patient communication system; and
automatically communicating the updated status of the patient to the authenticated individual with the portal associated with the patient.

10. The method according to claim 9, further including configuring a patient filter of the patient communication system to limit types of status updates of the patient automatically communicated.

11. The method according to claim 9, wherein authenticating the individual includes authenticating a remote device associated with the individual and automatically communicating the updated status of the patient includes the portal pushing the status update to the remote device.

12. The method according to claim 9, wherein updating the status of the patient includes the patient inputting a status update into the patient communication device, the patient communication device communicating the status update to the server of the patient communication system.

13. The method according to claim 12, wherein the patient inputs a status update from a list of predefined status updates.

14. The method according to claim 9, wherein the facility update device is part of a medical communication system including a medical device in communication with a data collection server in communication with an application server, the medical communication system automatically updating the status of the patient to server of the patient communication system.

15. The method according to claim 14, wherein the medical device of the medical communication system updates the status of the patient.

16. A computer readable medium having embodied thereon a program, the program being executable by a processor for performing a method for communicating the status of a patient within a medical facility to identified individuals, the method comprising:
identifying the individual to receive status updates of the patient from a patient communication system, the patient communication system including:
a patient communication device;
a facility update device;
a server; and
a portal associated with the patient;
authenticating the individual within the patient communication system;
updating the status of the patient within the patient communication system; and
automatically communicating the updated status of the patient to the authenticated individual with the portal associated with the patient.

17. The computer readable medium according to claim 16, further including configuring a patient filter of the patient communication system to limit types of status updates of the patient automatically communicated.

18. The computer readable medium according to claim 16, further including configuring a facility filter of the patient communication system to limit types of status updates of the patient automatically communicated.

19. The computer readable medium according to claim 16, wherein updating the status of the patient includes the facility update device communicating a status update to the server of the patient communication system.

20. The computer readable medium according to claim 19, wherein a clinician inputs a status update into a clinician interface of the facility update device.
